(19) United States
(12) Patent Application Publication
(10) Pub. No.: US 2008/0152173 A1
(43) Pub. Date: Jun. 26, 2008

(54) VOICE RECORDER PEN

(75) Inventor: Ha-Young Lee, Seoul (KR)

Correspondence Address: EDWARDS ANGELL PALMER & DODGE LLP, P.O. BOX 55874, BOSTON, MA, 02205, US

(73) Assignee: ESONIC CO., LTD, Seoul (KR)

(21) Appl. No.: 11/942,965

(22) Filed: Nov. 20, 2007

(30) Foreign Application Priority Data
Nov. 20, 2006 (KR) 10-2006-0114495

(51) Int. Cl. H04R 3/00

(52) U.S. Cl. 381/122

(57) ABSTRACT

A voice recorder pen includes a body including a power supply and a PCB and a pen tip portion coupled to one end of the body. The body includes a power supply and a PCB. The power supply includes a battery to supply power to the PCB. The PCB includes thereon a microphone for voice detection, a record on/off switch for turning a record function on/off, a microcomputer/memory unit for amplifying and converting voice detected by the microphone into a digital signal and storing the digital signal, and a connection portion adapted to be connected to an external operating unit. An operating clip is provided on an outer surface of the body. The operating clip is coupled to the record on/off switch to operate the record on/off switch. Accordingly, the configuration of the body is simplified, increasing the convenience of the use of the voice recorder pen, while reducing the body size.

### CROSS-REFERENCE TO RELATED APPLICATION

This application claims under 35 U.S.C. §119(a) the benefit of Korean Patent Application No. 10-2006-0114495 filed on Nov. 20, 2006, the entire contents of which are incorporated herein by reference.

### TECHNICAL FIELD

The present invention relates to a voice recorder pen, and more particularly to a voice recorder pen in which a record on/off switch provided in the body of the pen can be controlled by an operating unit provided outside the pen, thereby being capable of simplifying the configuration of the body and increasing user convenience.

### BACKGROUND ART

FIG. 1 is a perspective view of a conventional voice recorder pen and FIG. 2 is a cross-sectional view of the conventional voice recorder pen. As shown in FIGS. 1 and 2, the conventional voice recorder pen includes a body 10, on which an operating unit 10a and a volume controller 40 are provided, and a pen tip portion 90 connected to the bottom of the body 10. The operating unit 10a includes a plurality of operating buttons 10c such as play, fast forward, rewind, and power buttons and a display window 10b for displaying operating states of the functions of the buttons 10c when the buttons are operated. The volume controller 40 is used to control the volume of reproduced voice (or sound).

Generally, the operating unit 10a is provided on one side of the body 10. A fastening cap 20 is coupled to the top of the body 10 and a bottom cover 80 is coupled to the bottom of the body 10.

The plurality of operating buttons 10c such as play, fast forward, rewind, and power buttons and the display window 10b for displaying operating states of the functions of the buttons 10c when the buttons are operated are connected to a circuit board 10c-3 in the body 10.

Physical force can be often applied to the body of a pen in its daily use, for example when the pen falls. Similar incidents may also occur to a voice recorder pen. This may cause small failures of the voice recorder pen including a number of electronic parts. In some cases, even a small failure such as single part failure may require replacement of the entirety of circuit board 10c-3 or display window 10b. This causes problems in terms of cost, requiring that users very carefully handle the voice recorder pen.

For a voice recorder pen with a small size, its operating unit 10a should be reduced to a small size and its operating buttons 10c such as play, fast forward, rewind, and power buttons are thus too close to each other in the small operating unit 10a. This may cause users to confuse the buttons 10c with each other when operating them, thereby causing inconvenience in using the voice recorder pen. Thus, there is no choice but to manufacture voice recorder pens with a larger size than general pens.

In addition, since the operating buttons 10c of the conventional voice recorder pen are exposed on the body, the buttons may be operated by others, which causes security problems when it is necessary to protect privacy and confidentiality.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention has been made in view of the above problems, and it is an object of the present invention to provide a voice recorder pen, wherein an operating unit and an output unit are provided outside a body of the voice recorder pen using a wired remote controlling method and a record on/off switch is provided inside the body while the operating unit provided outside the body to control the record on/off switch is coupled to the record on/off switch through a connection portion, so that the configuration of the body can be simplified, anyone can easily use the voice recorder pen by operating a simple operating button, the original functions of the recorder can be emphasized to increase the efficiency, the size of the body of the voice recorder pen can be reduced to be smaller than that of the conventional voice recorder pen to make it possible to design the voice recorder pen like an actual pen, and security can also be increased.

In accordance with the present invention, the above and other objects can be accomplished by the provision of a voice recorder pen comprising a body including a printed circuit board (PCB) and a power supply for supplying power to the PCB; and a pen tip portion coupled to one end of the body. The PCB includes thereon a microphone for voice detection, a record on/off switch for turning record function on/off, a microcomputer/memory unit for amplifying and converting voice detected by the microphone into a digital signal and storing the digital signal, and a connection portion adapted to be connected to an external operating unit. An operating clip is provided on an outer surface of the body, the operating clip being coupled to the record on/off switch on the PCB so as to be able to operate the record on/off switch.

In a preferred embodiment, the operating clip includes an operating pin coupled to the record on/off switch on the PCB and a fastening pin formed with the operating pin to attach the voice recorder pen to clothing. Preferably, the fastening pin may be formed integrally with the operating pin.

In another preferred embodiment, the operating pin of the operating clip is formed so as to correspond to an operating direction of the record on/off switch of the PCB.

In still another preferred embodiment, the operating unit includes a connection jack formed on one side of the operating unit, an output unit formed on another side thereof, and a controller for controlling the power supply and the PCB. The connection jack is adapted to be inserted into the connection portion of the PCB. The output unit is provided for outputting voice stored in the microcomputer/memory unit of the PCB.

In a further preferred embodiment, the controller of the operating unit includes a plurality of operating buttons with play, fast forward, rewind, and power on/off functions.

In yet a further preferred embodiment, the controller of the operating unit may further include a display, such as an LCD window, for displaying operating states.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view of a conventional voice recorder pen;

FIG. 2 is a cross-sectional view of the conventional voice recorder pen;

FIG. 3 is a perspective view of a voice recorder pen according to a preferred embodiment of the present invention;

FIG. 4 is a cross-sectional view of the voice recorder pen of FIG. 3;

FIGS. 5A and 5B are enlarged cross-sectional views of a part A of FIG. 4 in accordance with a preferred embodiment of the present invention; and

FIGS. 6A and 6B are enlarged cross-sectional views of the part A of FIG. 4 in accordance with another preferred embodiment of the present invention.

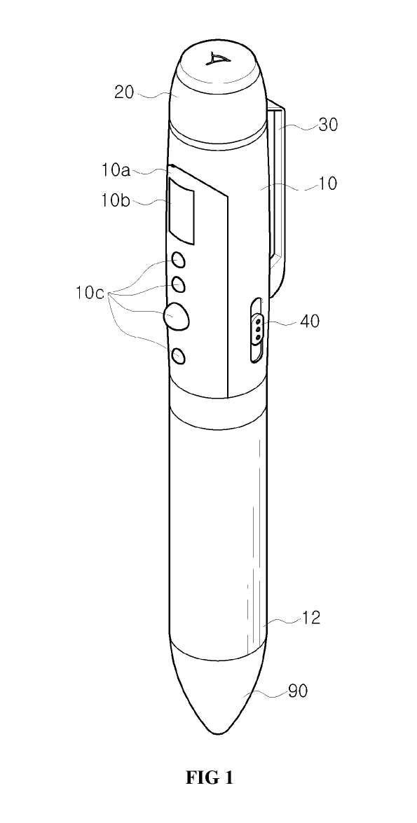

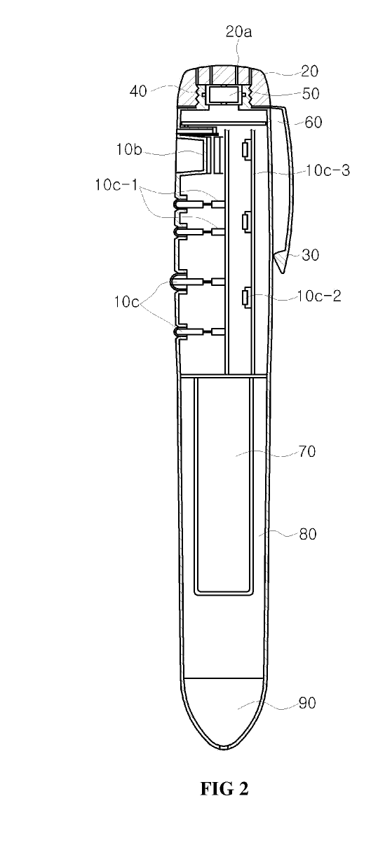

### DETAILED DESCRIPTION

Reference will now be made in detail to the preferred embodiments of the present invention, examples of which are illustrated in the drawings attached hereinafter, wherein like reference numerals refer to like elements throughout. The embodiments are described below so as to explain the present invention by referring to the figures.

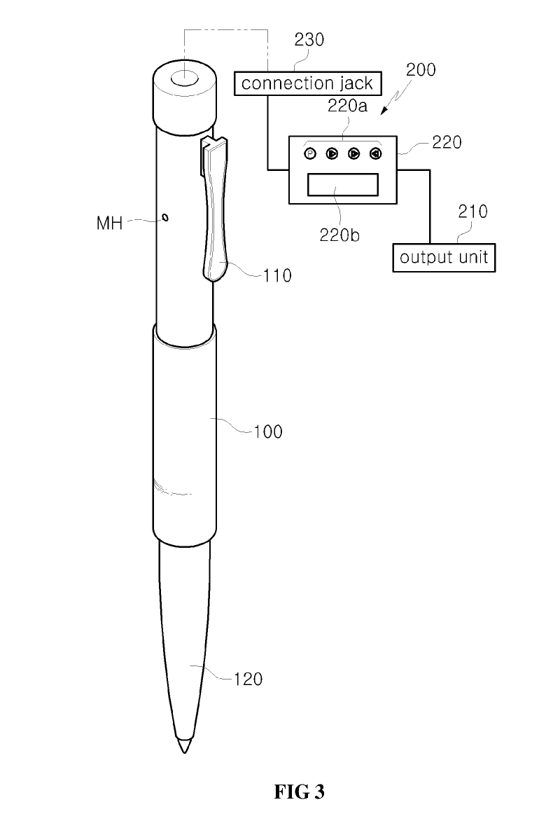

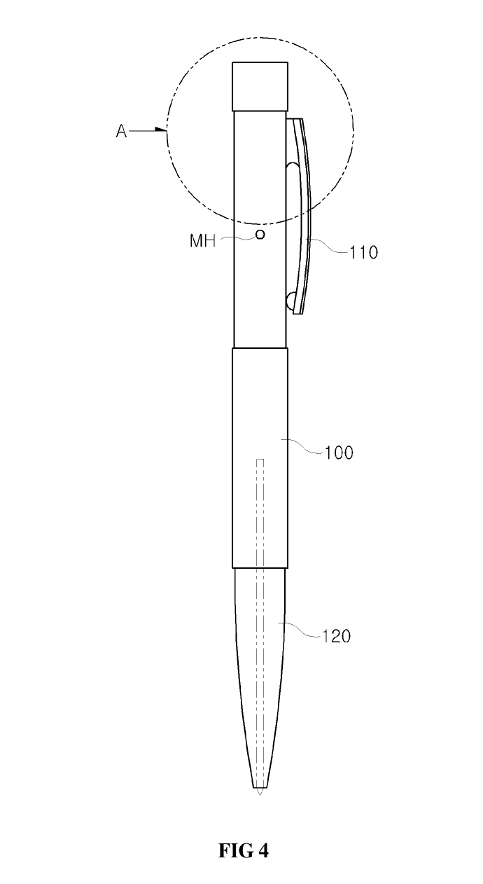

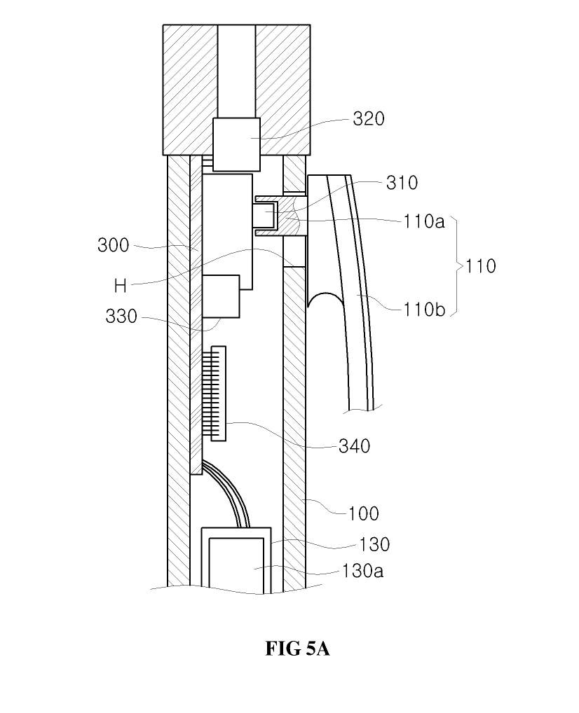

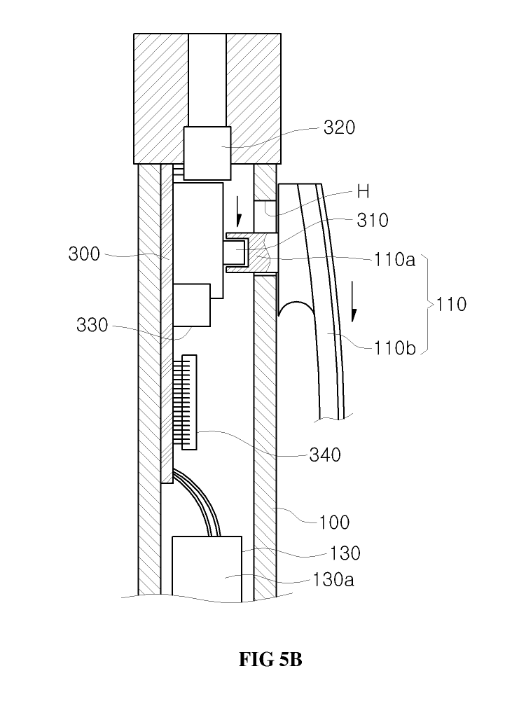

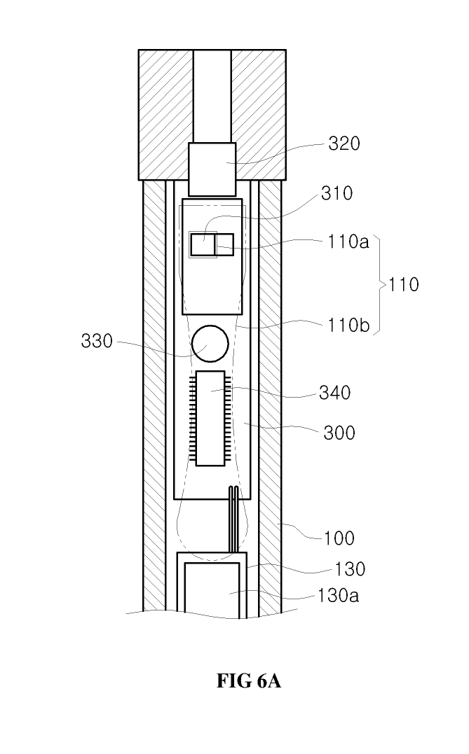

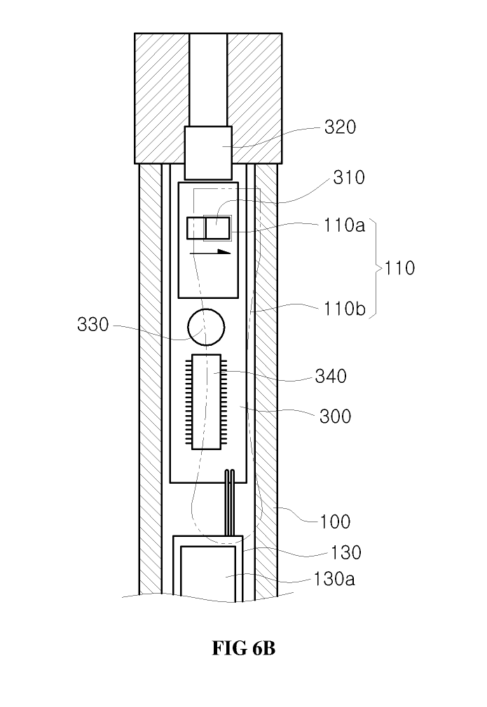

FIG. 3 is a perspective view of a voice recorder pen according to a preferred embodiment of the present invention, FIG. 4 is a cross-sectional view of the voice recorder pen of FIG. 3, FIGS. 5A and 5B are enlarged cross-sectional views of a part A of FIG. 4 in accordance with a preferred embodiment of the present invention, and FIGS. 6A and 6B are enlarged cross-sectional views of the part A of FIG. 4 in accordance with a preferred embodiment of the present invention.

As shown in FIGS. 3 to 6, a voice recorder pen according to a preferred embodiment of the present invention includes a body 100 and a pen tip portion 120 coupled to one end of the body 100. The body 100 includes a power supply 130 and a printed circuit board (PCB) 300. The power supply 130 includes a battery 130a to supply power to the PCB 300. The PCB 300 includes thereon a microphone 330 for voice detection, a record on/off switch 310 for turning a record function on/off, a microcomputer/memory unit 340 for amplifying and converting voice detected by the microphone 330 into a digital signal and storing the digital signal, and a connection portion 320 connected to an external operating unit 200.

The voice recorder pen is driven by power received from the battery 130a of the power supply 130. An operating clip 110 is provided on the outer surface of the body 100 to allow the user to record voice using the operating clip 110.

The operating clip 110 includes an operating pin 110a coupled to the record on/off switch 310 and a fastening pin 110b formed, preferably integrally, with the operating pin 110a to attach the voice recorder pen to clothing.

The body 100 has a through hole H on its outer wall and the operating pin 110a of the operating clip 110 is coupled to the record on/off switch 310 on the PCB 300 through the through hole H. The through hole H is shaped so as to correspond to the operating direction of the record on/off switch 310. Specifically, the through hole H is formed as a vertically extending hole if the record on/off switch 310 is operated (for example, flipped) up and down and as a horizontally extending hole if the record on/off switch 310 is operated left and right.

Accordingly, as shown in FIGS. 6A and 6B, the operating pin 110a of the operating clip 110 mounted on the outer surface of the body 100 is formed to suit the record on/off switch 310 of the PCB 300 which is operated up and down or left and right and the operating pin 110a is then coupled to the record on/off switch 310. Thus, the user can perform voice recording simply by operating the operating clip 110 left and right or up and down. A microphone hole MH is also formed through the outer wall of the body 100.

Voice detected by the microphone 330 is converted into an electrical signal, which is then stored in the microcomputer/memory unit 340 provided on the PCB 300.

FIGS. 5A and 5B are enlarged cross-sectional views of the part A of FIG. 4 in an embodiment where the record on/off switch 310 is operated up and down and FIGS. 6A and 6B are enlarged cross-sectional views of the part A of FIG. 4 in another embodiment where the record on/off switch 310 is operated left and right. As shown in FIGS. 3, 5A, 5B, 6A and 6B, an operating unit 200 is used to output the voice stored in the microcomputer/memory unit 340. The operating unit 200 includes a connection jack 230, which is formed on one side of the operating unit 200, being configured to be inserted into the connection portion 320 of the PCB 300, an output unit 210, which is formed on another side of the operating unit 200, for outputting voice stored as an electrical signal in the microcomputer/memory unit 340 of the PCB 300, and a controller 220 for controlling the power supply 130 and the PCB 300.

The connection jack 230 of the operating unit 200 is to be inserted into the connection portion 320 of the PCB 300. The controller 220 includes a plurality of operating buttons 220a with play, fast forward, rewind, and power on/off functions and a display such as an LCD window 220b for displaying operating states of the operating buttons 220a when the operating buttons 220a are used. The controller 220 performs a control operation to allow the output unit 210 to output voice stored as an electrical signal in the microcomputer/memory unit 340.

The electrical signal stored in the microcomputer/memory unit 340 of the PCB 300 is provided to the controller 220 of the operating unit 200 through the connection jack 230 of the operating unit 200 inserted into the connection portion 320 of the PCB 300. The controller 220 controls the electrical signal received from the microcomputer/memory unit 340 according to operations of the plurality of operating buttons on the controller 220 to output voice corresponding to the electrical signal through the output unit 210.

Any device which can output voice can be used as the output unit 210. Examples of the output unit 210 include an earphone, a speaker, and an amplifier.

As is apparent from the above description, the present invention provides a voice recorder pen with a variety of features and advantages. For example, an operating unit and an output unit are provided outside a body of the voice recorder pen using a wired remote controlling method and a record on/off switch is provided inside the body while the operating unit provided outside the body to control the record on/off switch is coupled to the record on/off switch through a connection portion. Accordingly, the configuration of the body can be simplified, anyone can easily use the voice recorder pen by operating a simple operating button, the original functions of the recorder can be emphasized to increase the efficiency, the size of the body of the voice recorder pen can be reduced to be smaller than that of the conventional voice recorder pen to make it possible to design the voice recorder pen like an actual pen, and security can also be increased.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A voice recorder pen comprising:
a body including a printed circuit board (PCB) and a power supply for supplying power to the PCB; and
a pen tip portion coupled to one end of the body,
wherein the PCB includes thereon a microphone for voice detection, a record on/off switch for turning record function on/off, a microcomputer/memory unit for amplifying and converting voice detected by the microphone into a digital signal and storing the digital signal, and a connection portion adapted to be connected to an external operating unit; and
wherein an operating clip is provided on an outer surface of the body, the operating clip being coupled to the record on/off switch on the PCB so as to be able to operate the record on/off switch.

2. The voice recorder pen according to claim 1, wherein the operating clip includes an operating pin coupled to the record on/off switch on the PCB and a fastening pin formed with the operating pin to attach the voice recorder pen to clothing.

3. The voice recorder pen according to claim 2, wherein the operating pin of the operating clip is formed so as to correspond to an operating direction of the record on/off switch of the PCB.

4. The voice recorder pen according to claim 1, wherein the operating unit includes:
a connection jack formed on one side of the operating unit, which is adapted to be inserted into the connection portion of the PCB;
an output unit formed on another side of the operating unit for outputting voice stored in the microcomputer/memory unit of the PCB; and
a controller for controlling the power supply and the PCB.

5. The voice recorder pen according to claim 4, wherein the controller of the operating unit includes a plurality of operating buttons with play, fast forward, rewind, and power on/off functions.

6. The voice recorder pen according to claim 4, wherein the controller of the operating unit further includes a display for displaying operating states.

7. The voice recorder pen according to claim 6, wherein the display is an LCD window.

8. The voice recorder pen according to claim 5, wherein the controller of the operating unit further includes a display for displaying operating states.

9. The voice recorder pen according to claim 8, wherein the display is an LCD window.
